(19) United States
(12) Patent Application Publication
(10) Pub. No.: US 2008/0317010 A1
(43) Pub. Date: Dec. 25, 2008

(54) SYSTEM AND METHOD FOR SIGNALING OPTIMIZATION IN IMS SERVICES BY USING A SERVICE DELIVERY PLATFORM

(75) Inventors: Shamim A. NAQVI, Boston, MA (US); William Kwan, Westborough, MA (US)

Correspondence Address: WILMERHALE/BOSTON, 60 STATE STREET, BOSTON, MA, 02109, US

(73) Assignee: Aylus Networks, Inc.

(21) Appl. No.: 11/767,354

(22) Filed: Jun. 22, 2007

(51) Int. Cl. H04L 12/66

(52) U.S. Cl. 370/355

(57) ABSTRACT

Systems and methods for reducing signaling traffic in the provision of data services to a plurality of user endpoints (UEs). The UEs are in communication with a radio access network, which is the in communication with an IP multimedia subsystem (IMS) core for providing data service to the UEs, the data service including a videoshare service. The systems and methods involve providing an application server (AS) that during operation communicates with the IMS core and serves as a data service registrar for the UEs, and providing logic in the AS configured to receive from a first UE of the plurality of UEs videoshare capabilities information of the first UE, cache the first UE videoshare capabilities information and send to a second UE of the plurality of UEs the cached first UE videoshare capabilities information.

### RELATED APPLICATIONS

This application is related to U.S. patent application Ser. No. 11/504,896, filed Aug. 16, 2006 and entitled “System and Method for Enabling Combinational Services in Wireless Networks by Using a Service Delivery Platform,” the entire contents of which are incorporated by reference.

### BACKGROUND

1. Field of the Invention

The invention generally relates to wireless networks and to IP multimedia subsystem (IMS) networks.

2. Description of Related Art

New types of services for wireless networks, called combinational services, have been the subject of recent proposals in 3GPP and other standardization bodies. The proposed combinational services typically involve a voice call that is simultaneously juxtaposed with the transmission of a multimedia object (i.e., a video file or live streaming from a camcorder integrated in the handset) from one participant to another in the ongoing voice call. One example of a combinational service would be a voice call between two subscribers that is augmented by transmitting a multimedia object from the caller to the called party. In this example, the caller or called party could use a video camera in his handset to show the second party an object in close proximity, e.g., an automobile or a house, and simultaneously converse with the second party. This service has been referred to as “videoshare” in some quarters. Other examples of possible combinational services include sharing video or music clips, images and photographs during ongoing phone calls. A feature common to these examples is augmenting a voice conversation by adding a multimedia feed to the same session. Some wireless service providers have begun to demonstrate early versions of such services such as videoshare by Cingular.

The prevailing state of the art proposes that the voice call in a combinational service be carried by a circuit-switched wireless network, such as the Public Land Mobile Network (PLMN), and that the multimedia session be carried by a packet-switched wireless network, such as the IP Multimedia Subsystem (IMS). Thus, the proposals envision two separate but simultaneous connections between the mobile handsets participating in the combinational service.

The circuit-switched PLMN and packet-switched IMS networks will now be described in greater detail.

In a circuit-switched network such as PLMN, users' network mobile handsets are connected to Base Transceiver Stations (BTS) through a radio access network. The BTS in turn are connected to a plurality of Base Station Servers (BSC) that in turn connect to a network of Mobile Switching Centers (MSC). The MSC provide wireless services to the users' handsets, and are also inter-connected with the Public Switched Telephone network (PSTN). This arrangement makes it possible for voice traffic to be carried between mobile handsets and landline telephone sets. The MSC in a wireless network effectively behaves as a switch that supports the mobility and roaming functions of a user's handset.

In the packet-switched network, services are generally supported by IP Multimedia Subsystem (IMS). The IMS architecture manages the network with several control functions, i.e., functional entities. The Breakout Gateway Control Function (BGCF) is an inter-working function that handles legacy circuit-switched traffic. A new function called the Media Gateway Control Function (MGCF) controls the Media Gateway (MGW). The Media Resource Function Processor (MRFP), which is controlled by the Media Resource Control Function (MRFC), performs media processing functions. An IMS session is controlled by a logical function called the Call State Control Function (CSCF). It is logically partitioned into three functional entities, the Proxy, Interrogating and Serving CSCFs. The Proxy Call State Control Function (P-CSCF) is the first contact point for a user's handset, also referred to herein as the User Entity (UE). The Interrogating CSCF (I-CSCF) is mainly the contact point within an operator's network for all IMS connections destined to a subscriber of that network operator, or a roaming subscriber currently located within that network operator's service area. The Serving CSCF (S-CSCF) actually handles the session states in the network. The IMS controls packet services among the different functional entities with signaling protocols such as Session Initiation Protocol (SIP), which is an IP-based signaling protocol designed for multimedia communications.

When a UE first powers on, logic residing in the UE initiates a “registration” procedure with the IMS core, first by requesting the radio access network to assign it an IP address. After it receives an IP address, the UE attempts to register as an IP-enabled endpoint with the IMS core, by sending a “register” request to the P-CSCF. Assuming that the UE is registering from a visiting domain, the P-CSCF then uses a Domain Name Server (DNS) to search for the UE's home domain S-CSCF. Once the P-CSCF locates the S-CSCF for the UE, it passes the “register” request to that S-CSCF. The S-CSCF contacts the Home Subscriber Subsystem (HSS), which looks up the UE's profile. This profile contains assorted information about the user, and what services the UE is authorized to use. A logical function in the S-CSCF called the “registrar” then authenticates the UE, e.g., verifies that the UE is legitimate.

The S-CSCF also loads Service Point Triggers (SPT) from the UE's. The SPT define the appropriate action for the S-CSCF to take when the UE requests a transaction. For example, if the UE requests voice mail service, the SPT triggers the S-CSCF to provide a connection to the appropriate voice mail application server for this request. So long as the UE is powered on, the SPTs for that UE are loaded into the S-CSCF, so a service request fires the appropriate trigger in the S-CSCF.

In the IMS architecture services, such as voice mail, push to talk, etc., are typically but not exclusively provided by specific Application Servers (AS). For example, if a UE requests a voice mail service the request is forwarded from the UE to the S-CSCF and onwards to a specific AS that provides voice mail service to the UE. As another example if the user wants to initiate an IMS call, it sends a SIP invite message to the S-CSCF, which may then contact the AS responsible for IMS calls, called the Back-to-Back User Agent (B2BUA), which initiates the IMS call flow.

In certain cases an AS may not be used; such services are sometimes referred to as “peer to peer” services. For example, it is possible to architect a combinational service such as “videoshare” in a peer to peer fashion as follows. Assume that handsets “A” and “B” are engaged in a circuit-switched voice call as per standard PLMN procedures. Special service logic resides in both handsets to effectuate videoshare service. This special service logic is typically integrated with the IMS-specific service logic previously referred to as UE. Without causing ambiguity we shall refer to the integrated service logic as UE. Moreover, we will use the terminology UE(A) and UE(B) to distinguish between the logic in the two handsets. Assume that during the ongoing voice call handset “A” is used to initiate a videoshare connection to “B.” UE(A) sends an IMS request (“SIP Invite”) to UE(B) via the S-CSCF (i.e., the S-CSCF acts as a proxy). This is necessary because UE(A) typically will not know how to locate and route the request to UE(B) which responds via the S-CSCF as appropriate. A series of requests and responses ensue, the resulting traffic being typically referred to as “signaling traffic;” the main purpose of the signaling traffic is to negotiate the specifics of the service, parameters such as codecs, capabilities of UE(A) and UE(B), etc. All signaling traffic traffic is mediated by the S-CSCF. Pursuant negotiations the media traffic (in the case of videoshare the media traffic will consist of the video data from “A” to “B”) may be initiated but in this case the media traffic may not be routed via the S-CSCF; it may be routed by IP network elements, such as routers, to the destination, obviating the S-CSCF.

As noted above, it is possible to architect combinational services in general and videostore service in particular in a “peer to peer” architecture. In such implementations the signaling traffic is mediated by the S-CSCF. This incurs a load on the S-CSCF.

However, deploying combinational services in general and videoshare service in particular using a “peer to peer” architecture is a costly undertaking.

### SUMMARY

Given the above description of combinational services in IMS networks it will be readily appreciated by skilled practitioners in the art that a service delivery platform intended to reduce the signaling traffic load on IMS network elements such as the S-CSCF would greatly benefit operators.

Under one aspect, a method of reducing signaling traffic in the provision of data services to a plurality of user endpoints (UEs), the UEs being in communication with a radio access network, the radio access network being in communication with an IP multimedia subsystem (IMS) core for providing data service to the UEs, the data service including a videoshare service, includes: providing an application server (AS) that during operation communicates with the IMS core and serves as a data service registrar for the UEs, and providing logic in the AS configured to: receive from a first UE of the plurality of UEs videoshare capabilities information of the first UE; cache the first UE videoshare capabilities information; and send to a second UE of the plurality of UEs the cached first UE videoshare capabilities information.

One or more embodiments include one or more of the following features. The logic in the AS is further configured to receive the first UE capabilities information as a result of initiating a capabilities exchange process with the first UE. The logic in the AS is further configured to initiate the capabilities exchange process with the first UE when the first UE registers with the AS. Under another aspect, a method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, includes: providing an application server (AS) that during operation communicates with the IMS core and serves as a data service registrar for the UEs; and providing logic in the AS configured to: receive a registration request from a first UE of the plurality of UEs; after receiving the registration request from the first UE, initiate a capabilities exchange process with the first UE; receive first UE capabilities information sent by the first UE during the capabilities exchange process; cache the received first UE capabilities information; and respond to a request received from a second UE of the plurality of UEs for the first UE capabilities information by retrieving and sending to the second UE the cached first UE capabilities information.

One or more embodiments include one or more of the following features. The first UE capabilities information includes information about videoshare capabilities of the first UE. The request from the second UE is received when the first and second UEs are connected by the circuit-switched network.

Under another aspect, a method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, includes: providing an application server (AS) that during operation communicates with the IMS core and with the circuit-switched network and that serves as a data service registrar for the UEs; and providing logic in the AS configured to: receive a registration request from a first UE of the plurality of UEs; after receiving the registration request from the first UE, initiate a capabilities exchange process with the first UE; receive first UE capabilities information sent by the first UE during the capabilities exchange process; cache the received first UE capabilities information; and when the first UE is connected to a second UE via the circuit-switched network, obtain the IP addresses of the first and second UEs using information retrieved from the circuit-switched network, retrieve the cached first UE capabilities information corresponding to the first UE IP address, and send the retrieved first UE capabilities information to the second UE via the IMS core using the second UE IP address.

In some embodiments, the logic in the AS is configured to obtain the IP addresses of the first and second UEs by retrieving phone numbers corresponding to the first and second UEs, and obtaining the IP addresses corresponding to the first and second UE phone numbers by using a database that associates phone numbers with IP addresses.

Under another aspect, a method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, includes: providing a registering application server (AS) that during operation communicates with the IMS core and serves as a data service registrar for the UEs; providing a presence AS that during operation communicates with the IMS core and provides presence service to the UEs; providing logic in the registering AS configured to retrieve from a first UE capabilities information for the first UE when the first UE registers with the IMS core, to retrieve from a second UE capabilities information for the second UE when the second UE registers with the IMS core, and to cache the first and second UE capabilities information; and providing logic in the presence AS configured to store a contact list of a first UE and, if a user corresponding to the second UE is in the first UE contact list, retrieve from the registering AS capabilities information for the second UE and send the second UE capabilities information to the first UE. In some embodiments, the logic in the presence AS is further configured to store a contact list of a second UE and, if a user corresponding to the first UE is in the second UE contact list, retrieve from the registering AS capabilities information for the first UE and send the first UE capabilities information to the second UE.

### BRIEF DESCRIPTION OF THE DRAWINGS

FIG. 1 illustrates an overview of the service delivery platform and its connections to the packet-switched networks.

### DETAILED DESCRIPTION

The present invention provides systems and methods for enabling reduction in signaling traffic in combinational services by using a service delivery platform.

Overview of Service Delivery Platform

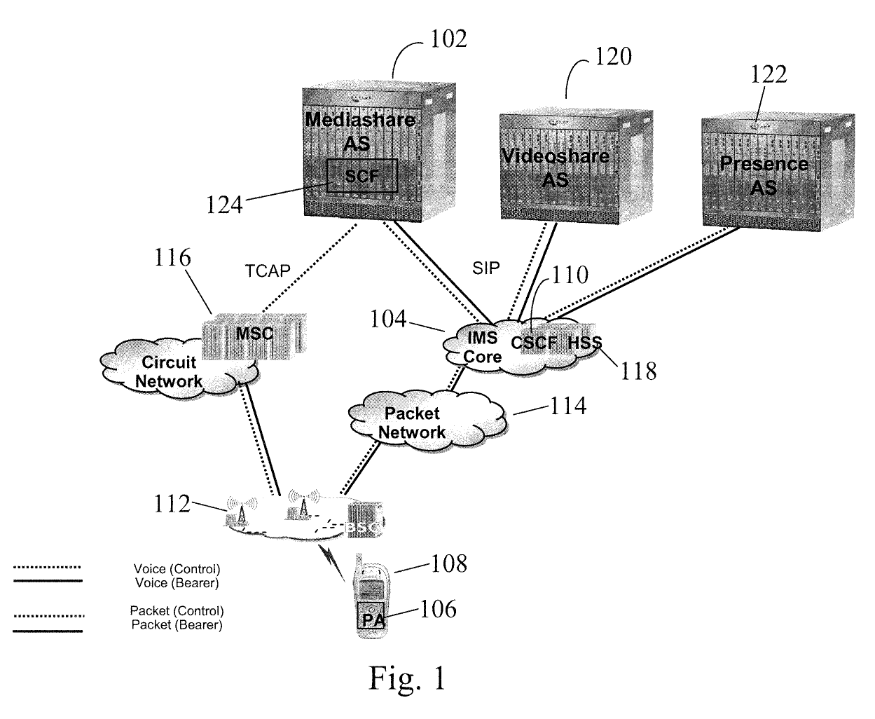

FIG. 1 is an overview of the service delivery platform and its connections to the packet-switched networks. We shall use the terms SN and AS interchangeably. The platform includes mediashare AS 102 that supports combinational services by communicating with the packet-based IMS core network 104. In particular, the mediashare AS 102 acts as an application server for combinational services. The service delivery platform also includes personal agent (PA) 106, which is a piece of service logic that resides in each UE 108. PA 106 sends messages to the mediashare AS 102 regarding services that the user would like to use, and also regarding its local resources and capabilities. Mediashare AS 102 then responds appropriately by making appropriate IMS network services available to the user. It should be noted that CSCF 110 interfaces with AS 102 using the ISC interface as specified by IMS literature.

The existing “3G” infrastructure includes radio access network 112, circuit-switched (CS) network, packet-switched (PS) network 114, and IMS core 104. As described above, the CS network includes Mobile Switching Center(s) (MSC) 116 that provides wireless voice services to UE 108 over radio access network. PS network 114 includes Serving GPRS Support Node (SGSN) and Gateway GPRS Support Node (GGSN) that act as the connection point between radio access network 112 and IMS core 104. IMS core includes CSCF 110 and HSS 118 that provide multimedia services to UE 108 via PS network 114 and radio access network 112. As is known to practitioners skilled in the art, radio access network 112 for combinational services needs to support simultaneous circuit and packet switched connections which in the current state of the art is only possible in Universal Mobile Telecommunications System (UMTS) networks.

The service delivery platform provides combinational services to UE 108 as follows. Mediashare AS 102 communicates with IMS core 104, and appears like a normal application server to the IMS network.

In IMS core 118, the CSCF 110 normally communicates with AS's in order to provide services to UE 108. Specifically, if a UE wants to communicate with CSCF 110, it sends a request to CSCF 11O which triggers a Service Point Trigger (SPT) in the CSCF. The SPT causes CSCF 110 to communicate appropriately with the AS. If UE 108 wants to communicate with an AS, i.e., to receive a service, it sends a SIP message to CSCF 110, which triggers an SPT that instructs the CSCF to contact an AS to provide that service. In the described service delivery platform, mediashare AS 102 is one such AS in communication with IMS core 104. If UE 108 wants to contact mediashare AS 102, it sends a SIP invite message to the CSCF, which generates an SPT for CSCF 110 to send the request to mediashare AS 102. As 102 then uses service logic to execute that request. Thus, in order to inter-work IMS and AS 102, the CSCF simply needs to be configured to recognize mediashare AS 102. This allows mediashare AS 102 to learn about the packet-based connections that UE 108 makes with the CSCF. Methods of interaction between an application server acting as a serving node and the IMS core are discussed in greater detail in U.S. patent application Ser. No. 11/283,038, the entire contents of which are incorporated herein by reference.

Additional application servers in communication with IMS core 104 provide data services to combinational services subscribers. For example, videoshare AS 120 provides videoshare service and presence AS 122 provides presence service.

To readily communicate with IMS core, mediashare AS 102 supports protocols for PS/IMS communications e.g., SIP.

Signaling Interactions for Videoshare Service

As described above, mediashare AS 102, acting as the SN, is connected to IMS core 104. Specifically, it is connected to CSCF 110 using the ISC interface.

For Videoshare service the following interactions take place.

When the handset is powered on, the UE service logic does a “registration” with the IMS core. The registration process is described in more detail below. The registration information is shared with third-party AS's such as the mediashare AS 102 that provide additional IMS services.

When a user initiates a circuit-switched voice call, a capability exchange (CE) occurs between the two UEs participating in the circuit-switched call. Note that neither of the two UEs at this juncture has initiated a videoshare request. They are merely engaged in a traditional voice call. Hence the signaling traffic related to the CE process is entirely incremental to and precedes the actual videoshare session. The CE process is described in more detail below.

If during an ongoing circuit-switched voice call between two parties, one of the participants in the call decides to initiate the videoshare service, the information gathered in the preceding CE process is used to initiate a one-way video session between the initiating handset and the receiving handset, i.e., the second party in the circuit-switched call. Both signaling and media (bearer) traffic are associated with this phase of the service.

Either of the two parties engaged in a videoshare service may initiate or terminate the videoshare service, without impacting the ongoing circuit-switched call. Multiple videoshare sessions may be initiated/terminated within the context of a single ongoing circuit-switched call.

If the circuit-switched voice call is terminated, any and all videoshare sessions associated with it are terminated as well.

Signaling Optimizations Associated with Videoshare

As has been mentioned above, the signaling traffic associated with the CE process is entirely incremental to the underlying voice-only call; the cost of this traffic is borne by the operator irrespective of whether a videoshare session is initiated or not.

In those situations when either one or both participants in the voice-only call are roaming in another wireless network, the cost of the signaling traffic due to the CE process, is borne by both operators of the “home” and “visited” network. Prior business arrangements are often used to settle the charges due to roaming subscribers. Thus, an operator who offers videoshare service may incur extraneous charges for voice-only calls due to roaming subscribers.

Each time the CE process takes place between a pair of UEs, about 8,000 bytes of information is exchanged via radio area network. Since this information is transferred for every voice call, regardless of whether one of the parties in the call actually uses the videoshare service, the amount of CE traffic is considerable. Therefore, reduction of such costs is of great value to operators.

In an embodiment of the present invention the service delivery platform mediashare AS 102 is added to the peer-to-peer videoshare architecture. As described earlier, AS 102 acts as a serving node and is connected to the CSCF through the ISC interface. AS 102 receives registrations of all videoshare subscribers, i.e., it behave as a third-party registrar.

In an enhancement of the usual functions provided by an AS, the present invention overloads the registration process of clients as follows. When a handset client, i.e., UE 108, is first powered on, it registers with IMS core 104 which in turn conveys the registration to mediashare AS 102 acting as a third-party registrar. AS 102 in concert with the service logic residing in the handset requests and receives capability information from the handset client. AS 102 then proceeds to cache this capability information.

If party A now engages in a voice-only call with party B, as described earlier the CE process will ensue and party A will send CE related signaling messages to party B, via CSCF 110 which forwards them to AS 102. Upon receipt of such messages, AS 102 will preferentially seek to answer party A's requests using cached information, in lieu of forwarding said messages to party B. Thus, signaling traffic from AS 102 to CSCF and onwards to party B is obviated. In particular, no signaling messages are transported by the radio access network 112 (RAN) connecting party B.

As an example of the efficacy of the present invention, consider the case of one million registered videoshare subscribers. Assume that some percentage of said subscribers make voice-only calls on a given day. Using commonly-accepted erlang-based traffic models for voice-only calls, the CE process will generate approximately 94 GB of signaling traffic data load on the RAN per day related to the voice-only calls. The present invention has the capability of reducing said traffic by up to 50%.

The present invention may be further enhanced as follows. In related application, U.S. patent application Ser. No. 11/504,896, it is shown that AS 102 (referred to in that application as the SN) has connectivity to the circuit-switched network via the TCAP interface, i.e., AS 102 may act as a Service Control Function (SCF) 124. For every voice-only call, using trigger detection points (TDP), AS 102 is capable of receiving and maintaining calling and called party numbers. As is well-known to practitioners skilled in the art, the ENUM database may be used to associate telephone numbers with IP addresses of handsets. Thus, information gleaned from TDP may be used by AS 102 to derive IP addresses of handsets engaged in a voice-only call. AS 102 may now proactively download previously cached capability information to the two handsets, obviating the need for either handset to initiate the CE process at all. The CE process is hence replaced by a download process initiated by AS 102. In this manner the AS may be used to further reduce signaling traffic due to the CE process. Since uplink RAN capacity is much scarcer than downlink RAN capacity, said enhancement to present affords further cost savings to the operator.

The present invention envisages further signaling optimizations by improving the “registration” process. Many operators who have or who are contemplating deploying IMS networks are also interested in deploying presence technology. Presence technology allows subscribers to dynamically track the availability of other subscribers identified in their “contact lists” or soi-disant “buddy lists.” Once capability information has been cached in AS 102, it may be proactively sent to presence server 122 from whence it may be dispensed by a download process to individual handsets. The capabilities information is sent from AS 102 to presence server 122 when the latter detects that a pair of subscribers that are in each other's contact list are registered. Thus, the presence information of members in a contact list may be supplemented by videoshare capability information, obviating the need to carry out an explicit CE process. Such piggy-backing of videoshare capability information on top of presence has the added benefit of using downlink RAN resources rather than scarcer uplink RAN resources.

The described embodiment enhances the current videoshare user experience when a voice call terminates before the CE process has completed. In current systems, when a call is initiated, the handset service logic sends out the first capabilities exchange message. Then the call is terminated or the network drops the call before the handset has received a reply to its request. This occurs, for example, when a first voice-only call is a short call that is terminated by the caller, or the radio network drops the call, or when the user presses a “videoshare” button on the handset more than once in rapid succession. When a second call ensues, now the handset state machine is still awaiting the completion of the previous transaction. Since it does not get a response, it waits, or goes into the timeout error handling, which causes further delay corresponding to the timeout interval, which is typically 128 seconds. Such a delay significantly degrades the user experience. In the described embodiment, such timeout delays are avoided because AS 102 responds to the CE message on behalf of the called handset. This terminates the “wait” sate in the calling handset state machine, and, when a second call is initiated, a second CE process can start without delay.

In current videoshare service implementations, delays can also be introduced if the called handset does not respond to the CE message, or if network congestion delays receipt of a response. In this case, the calling handset is made to wait for the response, and remains in the wait state for up to the timeout interval. In the described embodiment, the calling handset receives its response from AS 102, reducing network delay on the calling handset side of the network.

When AS 102 responds to CE messages by responding on behalf of one of the handsets involved in a call using its cached capability information, there is a risk that the cached information has become “stale,” i.e., that is no longer current. This occurs if, for example, one of the handsets has dropped out of 3G network coverage, or if its CI has, in fact, changes. To reduce the window of time in which cached information becomes stale, the following procedure is performed. Handset A is engaged in a voice call with handset B. Handset A initiates a CE with handset B and sends messages to AS 102 for onward transmittal to B. AS 102 holds this message for a predetermined period of time. Handset B initiates a CE with handset A and sends a CE message to AS 102 for onward transmittal to handset A. AS 102 also holds the message from handset B for a predetermined period of time. AS 102 then updates its cached capabilities information for both handsets A and B, and responds with the updated information to both handsets.

The above procedure for refreshing cached information is enhanced as follows to limit delays associated with waiting for update capabilities information to be received from one of the handsets. If, after receiving the CE message from handset A, AS 102 does not receive a CE message from handset B, it waits for a predetermined period of time, possibly receiving a second CE request from handset A, and then responds to handset A with handset B's cached capabilities information. Service logic in handset a will receive the response and terminate the state machine for outstanding CE requests. However, with this procedure it is possible that AS 102 responds with stale capabilities information from B.

It may be argued that the CE process is costly since it occurs at the outset of every voice-only call for a videoshare subscriber. It may therefore be considered to move the CE process to when a subscriber initiates the videoshare session. There are two disadvantages stemming from such a proposal. Firstly, the CE process entails a certain delay which will be added to the time a subscriber has to wait for the videoshare session to be initiated. This will result in a downgrading of the user experience. Second, the main purpose of the CE process from a service usability point of view is to inform the subscribers that videoshare is possible before they initiate the service. Such proactive information is expected to stimulate the usage of the service. Moreover, if the CE process is executed when a videoshare session is initiated and the CE process fails for any number of reasons (e.g., the second party is not a videoshare subscriber, or is not in a suitable 3G/UMTS network, or does not possess a suitable handset, etc.), the videoshare session will fail to initiate, leading to a downgrading of the user experience.

Extension to Services other than Videoshare

The present invention has been presented in the context of the videoshare service. It will be readily appreciated by practitioners skilled in the art that the introduction of mediashare AS 102 as an application server in (possibly, peer-to-peer) IMS services, and the role of mediashare AS 102 acting as a proxy for a handset, and responding to inquiries directed at said handset using previously cached information, are all potentially useful in other combinational services defined in an IMS core network.

Incorporated Patent References

Embodiments of the present invention build on techniques, systems and methods disclosed in earlier filed applications, referred to herein as the “incorporated patent references,” including but not limited to:
U.S. patent application Ser. No. 11/504,896, filed Aug. 16, 2006, entitled System and Method for Enabling Combinational Services in Wireless Networks By Using a Service Delivery Platform;
U.S. Provisional Patent Application No. 60/809,029, filed May 26, 2006, entitled System and Method for Supporting Combinational Services Without Simultaneous Packet and Circuit Connections;
U.S. patent application Ser. No. 11/166,470, filed Jun. 24, 2005, entitled System and Method to Provide Dynamic Call Models for Users in an IMS Network;
U.S. patent application Ser. No. 11/166,407, filed Jun. 24, 2005, entitled Method and System for Provisioning IMS Networks with Virtual Service Organizations Having Distinct Service Logic;
U.S. patent application Ser. No. 11/166,456, filed Jun. 24, 2005, entitled Method of Avoiding or Minimizing Cost of Stateful Connections Between Application Servers and S-CSCF Nodes in an IMS Network with Multiple Domains;
U.S. patent application Ser. No. 11/166,406, filed Jun. 24, 2005, entitled Mediation System and Method for Hybrid Network Including an IMS Network;
U.S. patent application Ser. No. 11/370,594, filed Mar. 8, 2006, entitled Associated Device Discovery in IMS Networks;
U.S. patent application Ser. No. 11/282,924, filed Nov. 18, 2005, entitled IMS Networks with A VS Sessions with Multiple Access Networks;
U.S. Provisional Patent Application No. 60/735,112, filed Nov. 9, 2005, entitled System and Method to Allow Interruption of Unicast Data Service Utilizing a Class B Handset or a Dual Mode Handset (DMH) to Inform it of a Circuit-Based Incoming call, so the Handset Can Accept the Call if the User Desires;
U.S. patent application Ser. No. 11/283,038, filed Nov. 18, 2005, entitled System and Method of Interworking Non-IMS and IMS Networks to Create New Services Utilizing Both Networks;
U.S. patent application Ser. No. 11/283,042, filed Nov. 18, 2005, entitled System and Method to Mediate Delivery of Legacy, Non-IMS Services into an IMS Network;
U.S. patent application Ser. No. 11/370,793, filed Mar. 8, 2006, entitled Digital Home Networks Having a Control Point Located on a Wide Area Network;
U.S. Provisional Patent Application No. 60/776,137, filed Feb. 23, 2006, entitled Enabling Combinational Services in Networks that Do Not Support Multiple Radio Access Bearers;
U.S. Provisional Patent Application No. 60/779,954, filed Mar. 7, 2006, entitled Using Telephony Interface for Invoking Data Services in Wireless Communication Networks;
U.S. patent application Ser. No. 11/709,469, filed Feb. 22, 2007, entitled System and Methods for IP Signaling in Wireless Networks;
U.S. Provisional Patent Application No. 60/918,863, filed Mar. 19, 2007, entitled Systems and Methods for Rendering Multimedia Objects as Incoming Voice Call Indicators;
U.S. patent application Ser. No. 11/787,635, filed Apr. 17, 2007, entitled Systems and Methods for IMS User Sessions with Dynamic Service Selection;
U.S. Provisional Patent Application No. 60/923,918, filed Apr. 17, 2007, entitled Systems and Methods for Real-Time Cellular-to-Internet Video Transfer; and
U.S. Provisional Patent Application No. 60/923,930, filed Apr. 17, 2007, entitled Systems and Methods for Preserving Digital Rights and Personal Content in Combinational Services,
   the contents of which are hereby incorporated by reference in its entirety. The present techniques, however, are not limited to systems and methods disclosed in the incorporated patent applications. Thus, while reference to such systems and applications may be helpful, it is not believed necessary to understand the present embodiments or inventions.

Other embodiments are within the following claims.

What is claimed is:

1. A method of reducing signaling traffic in the provision of data services to a plurality of user endpoints (UEs), the UEs being in communication with a radio access network, the radio access network being in communication with an IP multimedia subsystem (IMS) core for providing data service to the UEs, the data service including a videoshare service, the method comprising:
providing an application server (AS) that during operation communicates with the IMS core and serves as a data service registrar for the UEs, and
providing logic in the AS configured to:
receive from a first UE of the plurality of UEs videoshare capabilities information of the first UE;
cache the first UE videoshare capabilities information; and
send to a second UE of the plurality of UEs the cached first UE videoshare capabilities information.

2. The method of claim 1, wherein the logic in the AS is further configured to receive the first UE capabilities information as a result of the AS initiating a capabilities exchange process with the first UE.

3. The method of claim 2, wherein the logic in the AS is further configured to initiate the capabilities exchange process with the first UE when the first UE registers with the AS.

4. A method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, the method comprising:
providing an application server (AS) that during operation communicates with the IMS core and serves as a data service registrar for the UEs; and
providing logic in the AS configured to:
receive a registration request from a first UE of the plurality of UEs;
after receiving the registration request from the first UE, initiate a capabilities exchange process with the first UE;
receive first UE capabilities information sent by the first UE during the capabilities exchange process;
cache the received first UE capabilities information; and
respond to a request received from a second UE of the plurality of UEs for the first UE capabilities information by retrieving from an AS cache and sending to the second UE the cached first UE capabilities information.

5. The method of claim 4, wherein the first UE capabilities information includes information about videoshare capabilities of the first UE.

6. The method of claim 4, wherein the request from the second UE is received when a voice-only call between the first and second UEs is connected by the circuit-switched network.

7. A method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, the method comprising:
providing an application server (AS) that during operation communicates with the IMS core and with the circuit-switched network and that serves as a data service registrar for the UEs; and
providing logic in the AS configured to:
receive a registration request from a first UE of the plurality of UEs;
after receiving the registration request from the first UE, initiate a capabilities exchange process with the first UE;
receive first UE capabilities information sent by the first UE during the capabilities exchange process;
cache the received first UE capabilities information; and
when the first UE is connected to a second UE via the circuit-switched network, obtain the IP addresses of the first and second UEs using information retrieved from the circuit-switched network, retrieve from an AS cache the cached first UE capabilities information corresponding to the first UE IP address, and send the cached first UE capabilities information to the second UE via the IMS core using the second UE IP address.

8. The method of claim 7, wherein the logic in the AS is further configured to obtain the IP addresses of the first and second UEs by retrieving phone numbers corresponding to the first and second UEs, and obtain the IP addresses corresponding to the first and second UE phone numbers by using a database that associates phone numbers with IP addresses.

9. A method of reducing signaling traffic in the provision of data services to a plurality of user endpoints (UEs), the UEs being in communication with a radio access network, the radio access network being in communication with a circuit-switched network for providing voice service to the UEs and with an IP multimedia subsystem (IMS) core for providing data service to the UEs, the data service including a presence service provided by a presence AS in communication with the IMS core, the method comprising:
providing a registering application server (AS) that during operation communicates with the IMS core and serves as a data service registrar for the UEs;
providing logic in the registering AS configured to retrieve from a first UE capabilities information for the first UE when the first UE registers with the IMS core, to retrieve from a second UE capabilities information for the second UE when the second UE registers with the IMS core, and to cache the first and second UE capabilities information; and
providing logic in the presence AS configured to store a contact list of a first UE and, if a user corresponding to the second UE is in the first UE contact list, retrieve from the registering AS capabilities information for the second UE and send the second UE capabilities information to the first UE.

10. The method of claim 9, wherein the logic in the presence AS is further configured to store a contact list of a second UE and, if a user corresponding to the first UE is in the second UE contact list, retrieve from the registering AS capabilities information for the first UE and send the first UE capabilities information to the second UE.
